(19) United States
(12) Patent Application Publication
(10) Pub. No.: US 2012/0173393 A1
(43) Pub. Date: Jul. 5, 2012

(54) System and Method for Tracking and Managing the Relocation of Equipment and Inventory

(76) Inventors: Brandon Acuff, Aurora, IL (US); Rick Rowley, Barrington, IL (US); Susan Acuff, Germantown, TN (US)

(21) Appl. No.: 13/207,903

(22) Filed: Aug. 11, 2011

Related U.S. Application Data
(60) Provisional application No. 61/372,855, filed on Aug. 11, 2010.

(51) Int. Cl. G06Q 10/08

(52) U.S. Cl. 705/28

(57) ABSTRACT

A system to monitor and/or manage the logistics and transportation of equipment and/or inventory is disclosed. The system comprises a web server tier, an application server tier and a database tier that employ real time tracking, vendor consolidation and reporting capabilities in a single secure web interface. A method of monitoring and/or managing the logistics and transportation of equipment and/or inventory from origin to destination and final placement by using the system is also disclosed.

This application claims the benefit of and priority to U.S. Provisional Application No. 61/372,855, filed Aug. 11, 2010, and is entitled to that filing date for priority. The specification, figures and complete disclosure of U.S. Provisional Application No. 61/372,855 are incorporated herein by specific reference for all purposes.

### FIELD

The present disclosure relates generally to a system and method for tracking and managing the relocation of equipment and/or inventory. More specifically, the present disclosure relates to a comprehensive web based portal logistics system and method used to monitor and manage the logistics and transportation of equipment and inventory from origin to destination and final placement, with 100% accountability and visibility.

### BACKGROUND

Transporting equipment and/or inventory from origin to destination and final placement is a complicated undertaking for several reasons. First, multiple parties or participants comprising a project team may be involved with the managing and relocation of equipment and/or inventory, operating in a large, distributed geographic environment. Communication between all members of a project team is a fundamental piece of completing a successful relocation of such items. Because multiple parties or participants are involved and the working geographic environment is large, communication is easily a struggle and breakdowns in communication often occur.

Also, transporting equipment and/or inventory from origin to destination and final placement is complicated by the fact that the equipment and/or inventory being relocated may be heavy, highly sensitive or one of a kind, and thus not easily relocated. Examples include museum artifacts, priceless antiquities, uninsurable or irreplaceable items, military and national treasures, international treasures and items, precision manufacturing or assembly line machinery, flight simulators and other equipment requiring precise handling and leveling, humidity and temperature controlled assets and other precious cargo.

Additionally, the operational environment for large-scale and complex relocations has grown increasingly more challenging. Supply chains have increased in both global scale and complexity, requiring the integration of multiple third party software systems and products as well as multiple third party hardware platforms and systems in order to provide complete “end to end” tracking and communications capabilities. Lean manufacturing has led to more streamlined operations where each participant in the transportation supply chain has only those components needed to complete its discrete task. These issues have become important for logistics operators and trucking companies to achieve better asset visibility and improved coordination.

There is a need, therefore, for a system and method for tracking and managing the relocation of equipment and/or inventory that provide a user-friendly, web based solution that is designed and architected specifically to resolve project-delaying communication problems as well as to provide a total visibility, control, management, and reporting solution for an end to end project, no matter how large scale or complex the logistics project. Further, there is a need for a system and method for tracking and managing the relocation of equipment and/or inventory that provide a single secure point of command and control over the entire project, no matter how large or small the project. Still further, there is a need for a system and method for tracking and managing the relocation of equipment and/or inventory that provide constant and precise property accountability and visibility. In addition, there is a need for a system and method for tracking and managing the relocation of equipment and/or inventory that provide all parties involved in the relocation or project move the ability to see the present location and condition of the items and equipment as well as any and all issues concerning such items and equipment with twenty four hours a day, seven days a week, three hundred and sixty five days a year; in-transit visibility (ITV). And finally, there is a need for a system and method for tracking and managing the relocation of equipment and/or inventory that provide real time flow of communications, notifications and updates to the appropriate parties which are required to efficiently monitor, manage and control day to day operations of any relocation project.

### BRIEF SUMMARY

A system to monitor and/or manage the logistics and transportation of equipment and/or inventory is disclosed. The system comprises a web server tier, an application server tier and a database tier that employ real time tracking, vendor consolidation and reporting capabilities in a single secure web interface. A method of monitoring and/or managing the logistics and transportation of equipment and/or inventory from origin to destination and final placement by using the system is also disclosed.

### BRIEF DESCRIPTION OF THE DRAWINGS

So that the manner in which the recited features of the present invention can be better understood, certain drawings and/or flowcharts are appended hereto. It is to be noted, however, that the appended drawings illustrate only selected embodiments of the inventions and are therefore not to be considered limiting of scope, for the inventions may admit to other equally effective embodiments and applications.

FIG. 1 depicts a screenshot representative of commander's or executive dashboard according to one example embodiment.

FIG. 2 depicts a screenshot representative of a commander's or executive dashboard with status indicators, according to one example embodiment.

FIG. 3 depicts a top view of screenshot representative of a dynamic project scheduler, according to one example embodiment.

FIG. 4 depicts a bottom view of a screenshot representative of a dynamic project scheduler, according to one example embodiment.

FIG. 5 depicts a screenshot representative of an integrated inventory control asset group view, according to one example embodiment.

FIG. 6 depicts a screenshot representative of an asset image, according to one example embodiment.

FIG. 7 depicts a screenshot representative of a master location view, according to one example embodiment.

FIG. 8 depicts the CIA triad.

### DETAILED DESCRIPTION

The system is used to monitor and manage the logistics and transportation of equipment and/or inventory from origin to destination and final placement. The system is used for critical rigging and transportation moves from the planning phase to the final project signoff.

The system employs real time tracking, vendor consolidation and reporting capabilities in a single, secure web interface. The system can manage multiple tasks and functions at any one time. The system can connect and report on multiple, heterogeneous data sources, including weather and instantaneous satellite tracking. The system provides security services, including but not limited to authentication, encryption, and session management, to ensure that only authorized users can access the information provided. The system securely provides multiple levels of tiered and customizable notifications, document and image repositories, and additional customized workflows that are specific to the transportation and monitoring of heavy haul and sensitive and non-sensitive equipment.

The system includes real time Department of Transportation traffic, accident, and warning feeds, NOAA weather feeds, and real time alerts and notifications to key project team members of mission critical project issues. The system also supports drill down reporting capabilities for capturing and zoning in on detailed project issues, a specific piece or truckload of inventory, equipment/inventory movement logs, signed weight tickets, storing of electronic permits, and other critical project items as required for each relocation project.

The system allows a relocation project team to always have available the most up-to-date information via web, SMS, and email access methods, messages, and notifications. The system updates the entire project team on the exact, precise status of a task or shipment at any given moment.

The system connects people, processes, and information. The system is an integrated server platform which provides a customized project dashboard, web based logistics tracking and collaboration tools, enterprise content services such as dynamic scheduling, automatic adjustments, real time email and text based notifications to project team members, issues management and tracking, secure file storage, electronic inventory control with images, and real time ITV, weather and traffic feeds as well as scanned in signed documents such as bill of lading, certified weight tickets, and more.

The system is used by the owner of the equipment and/or inventory, as well as rigging and project management teams and partner carrier's crews, teams, and management. The system includes portal administrators and system experts to assist as needed throughout a project. The system provides each user with his or her own specific, unique view of the items that he or she is interested in on the project, security level permitting. The system provides views which range from the highest level commander's or executive dashboard to a detailed custom daily move report for a specific item in a specific “chalk” or scheduled move.

The system creates a single version of the facts related to the relocation and allows such facts to be viewed by the multiple parties or participants involved in a relocation project. The system allows all participants to see the location of equipment and/or inventory, dates and times equipment and/or inventory are scheduled to be moved, the present condition of equipment and/or inventory, and any issues with such information or any information needed from a particular participant at any time twenty four hours a day, seven days a week, three hundred and sixty five days a year.

The system may include the following server and network topology. In one embodiment, the software components included in installation of the system are the Windows Operating System, IIS, .NET Framework and SQL Server, but any other software components may be used as desired by one of skill in the art.

The system is designed to be scalable so that it can be configured to serve small workgroups, large enterprises, or serve public Internet sites. The platform is divided into several different services that can run on one server in a single server deployment or divided across multiple servers in a server farm deployment.

The system includes a base architecture having three tiers: a web server tier, an application server tier, and a database tier. In one embodiment, the base architecture is based on Microsoft Office Sharepoint Server 2007 technology platform but any other base architecture or platform may be used as the base architecture as desired by one of skill in the art.

The first tier of the system is the web server tier. In one embodiment, the web service tier may be network load balanced.

The second tier of the system is the application server tier. The application server tier contains a service broker which handles multiple services. In one embodiment, the service broker may handle services including search, index, audience, user profiles, my sites, BDC, and Excel services but may also handle other services as desired by one of skill in the art. In one embodiment, application server tier has one service broker that provides multiple services. In another embodiment, the application server tier has a plurality of service brokers that each provide multiple services.

The third tier of the system is the database tier. In one embodiment, the database tier consists of standard SQL Server 2005 or SQL Server 2005 Cluster of servers but the database tier may consist of any other server as desired by one skilled in the art.

On the network, there are several other areas that relate to the security of the system. Servers exist as nodes on a TCP/IP network and networks can be running a wide variety of hardware including switches, routers, firewalls, and load balancers. The network security of a system server farm depends upon the configuration on these network devices. For example, a network may be configured with multiple network segments, DMZs, or VLANs. The system can be configured to operate in unique TCP/IP network environments.

The system provides a single, secure, point of command and control over the entire project, no matter how large or small. The system uses a single web based interface having a commander's or executive dashboard that displays overall project health status indicators for a relocation or project move. In one embodiment, project health status indicators may include easy to read green, yellow, and red display.

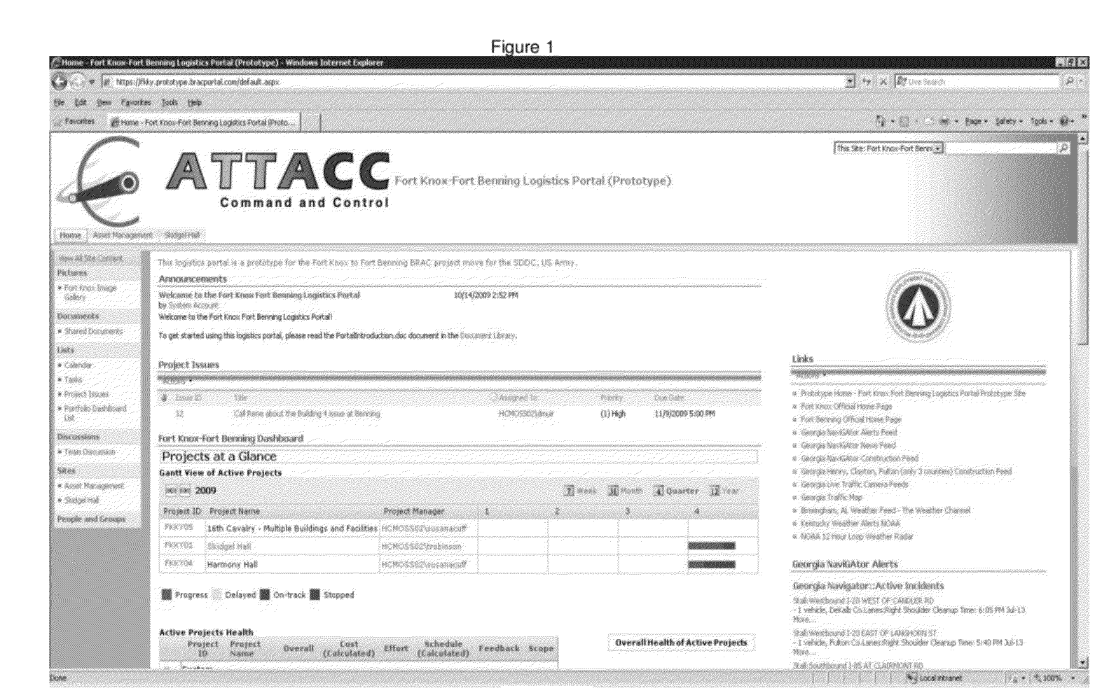

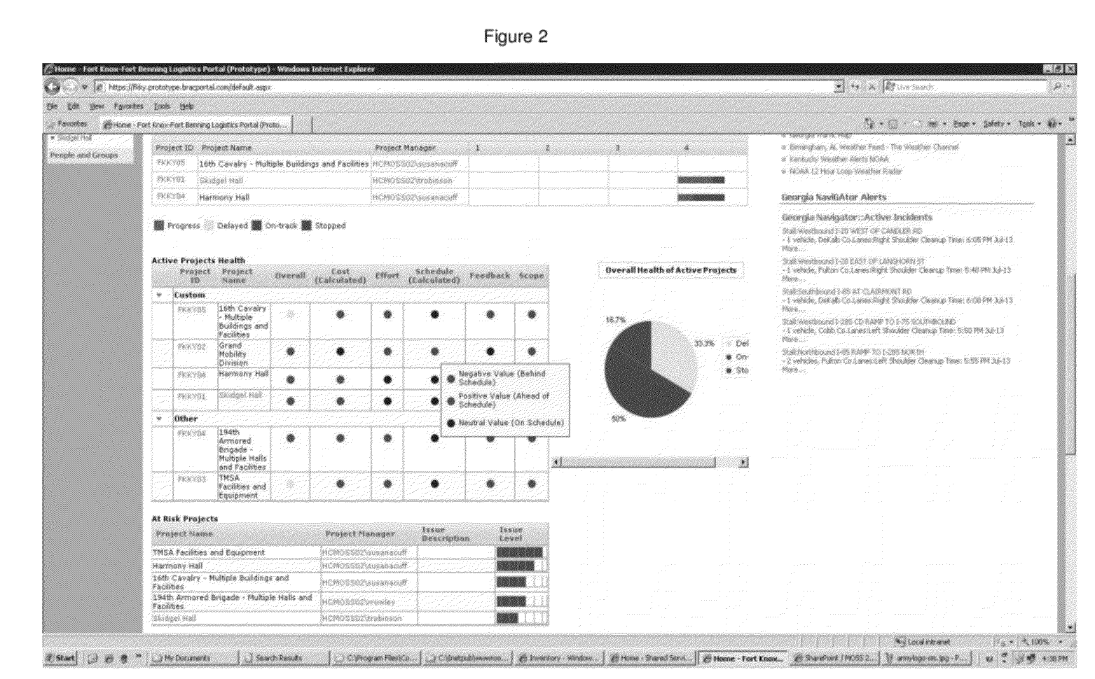

Referring to FIGS. 1 and 2, in one embodiment, the system provides a commander's or executive dashboard that provides a high level visual overview of the overall project health in red, yellow, and green status colors. In one embodiment, dashboard is customizable. Dashboard may include key items such as project schedules, project budget, and project issues. Key items such as timeline/schedule, budget, and issues can be tracked in the dashboard. Detailed reporting is also available for the participants to be able to drill into operations at a more granular level as required.

In one embodiment, the system provides real time flow of communications and updates required to efficiently monitor, manage, and control day to day operations of a relocation project. In one embodiment, the system includes a dynamic project scheduler. The dynamic project scheduler allows changes to a schedule to be updated or inputted by a team member in the dynamic project scheduler. Once changes are inputted, the dynamic project scheduler automatically notifies and adjusts all downstream personnel, resources and schedules. Reporting as to why a change must occur may be automatically reported. The dynamic project scheduler thus reduces any delays or damages that changes to an original schedule may cause and allows project/relocation to continue efficiently.

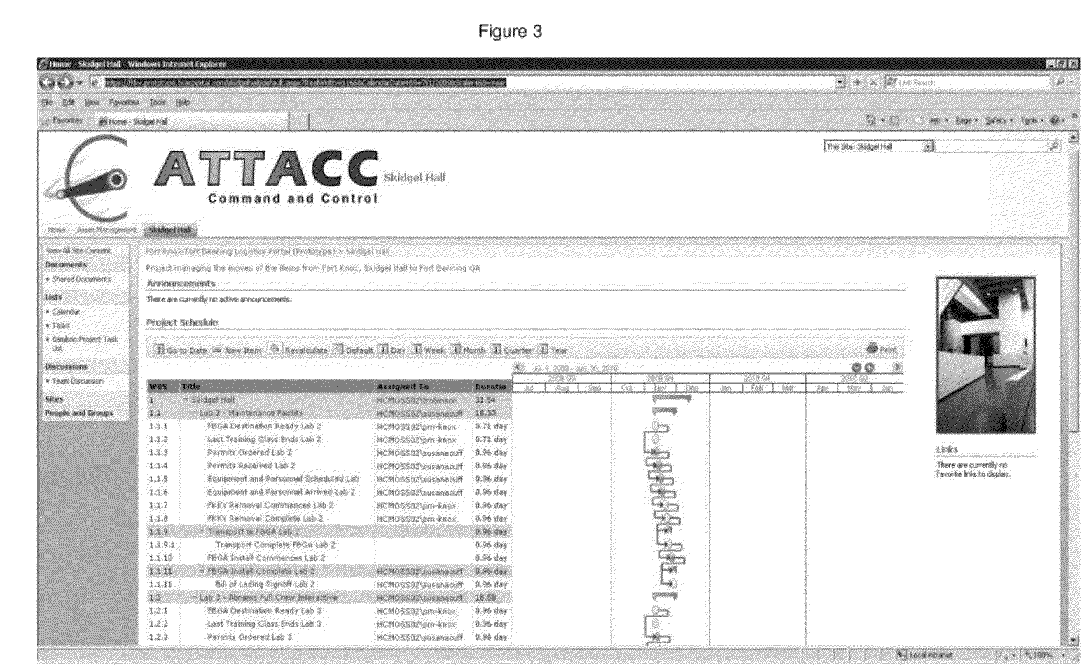

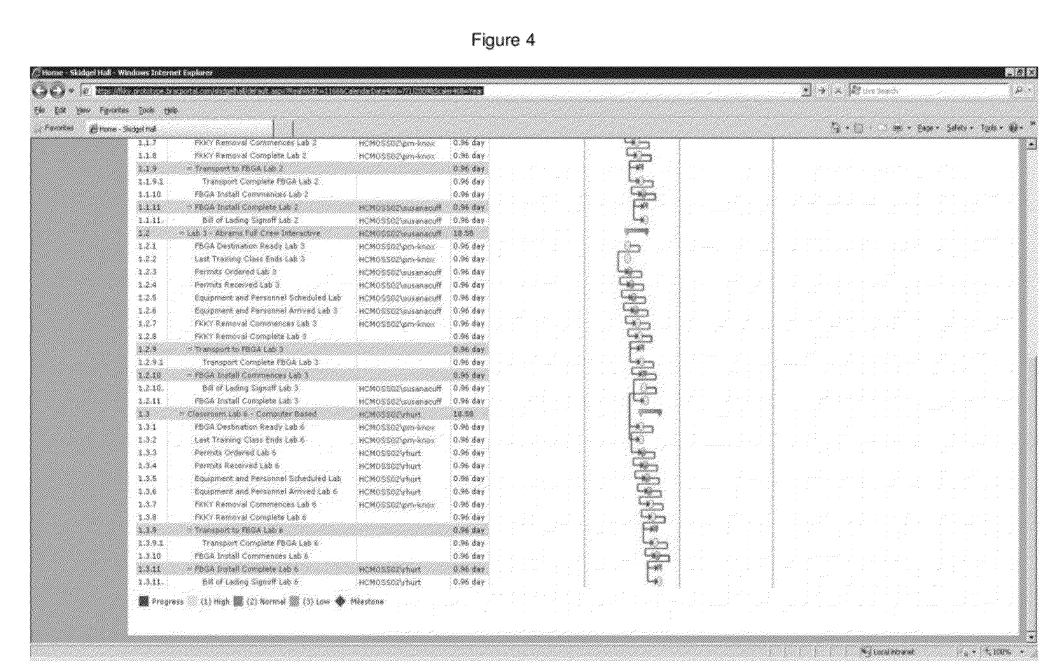

Referring to FIGS. 3 and 4, screenshots and examples representative of a dynamic project scheduler for a sub project are shown. One relocation project may include a master schedule as well as a sub project schedules. Typically, there will be a schedule for each chalk that is ultimately tied together into the single overarching master schedule. The system manages and stores the schedule. All chalks will be tied to each other and driven off of the master project schedule. As changes occur, a system administrator may enter the changes into the system. Automatic updates and accommodations will then ripple throughout the system. However, the hard chalk dates and chalk window to move will always be maintained.

Referring again to FIGS. 3 and 4, each line item listed represents a step or task in the schedule. Each step or task is listed, as well as to whom it is assigned, when it is scheduled to start, finish, and on which other project tasks in the schedule it may depend.

The system may include a number of other features that a project team may use in the overall and day to day operations of a relocation project move, including, but not limited to:
Slide and picture libraries;
Announcements used for breaking news and notifications;
Discussion boards;
Master contact list;
The master chalk schedule (including both the original schedule plus the actual schedule—the master chalk schedule automatically accommodates any schedule shifts or unforeseen elements and automatically adjusts the subsequent scheduled items if they are affected);
Electronic master inventory list and tracking with photos and images support at origin and destination;
Real time in transit visibility (ITV) of trucks, trailers, inventory, and assets;
Real time NOAA and DOT weather and traffic feeds;
Commander's or executive dashboard reporting—schedule, budget, issues, overall health; and
Drill down detailed operational reporting.

The system provides asset management and electronic inventory control to maintain 100% property accountability by integrating and leveraging a plurality of third party technology or solution into the single secured web interface. For example, in one embodiment the system integrates asset management and inventory tracking systems and solutions. Asset management provides fast, easy inventory/asset search and real time tracking of assets and inventory items.

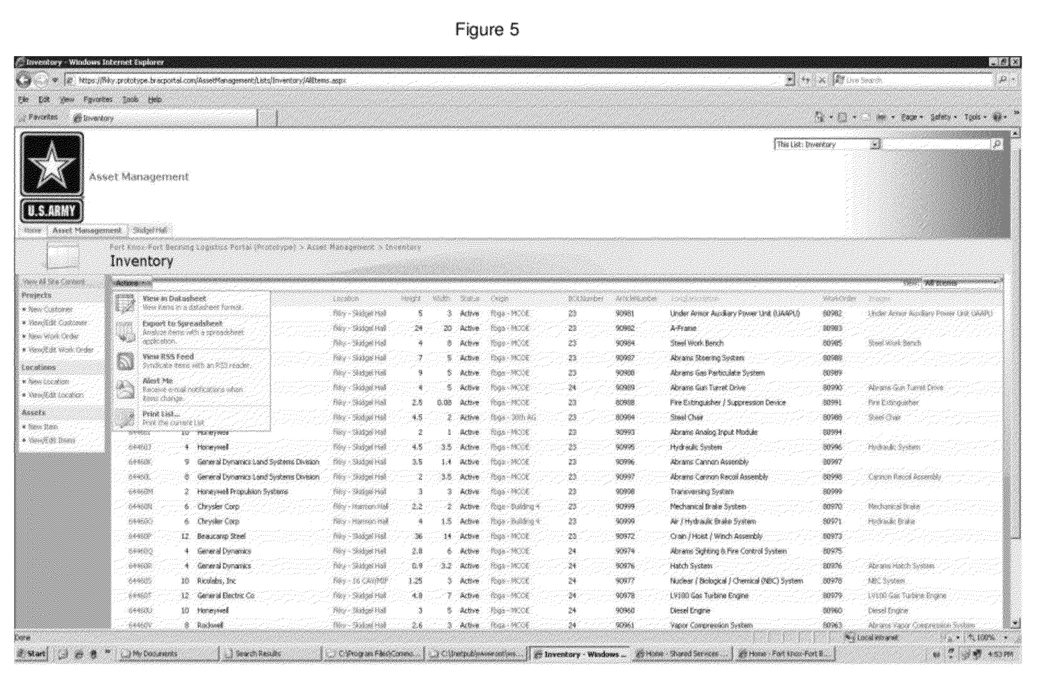

Referring now to FIG. 5, the screenshot represents a particular asset group. An asset group is a list of all the items on a particular truck or trailer as part of any given chalk. The system with asset management allows the following features among others: inventory/asset search, built in sorting and filtering of the assets, export to Excel for reporting and analysis, notifications when any of these assets change status, print capabilities of a partial or complete asset list, sorted/filtered report, and asset images available for viewing in further detail, as well as support for multiple time and date stamped images per asset.

The system with integrated electronic inventory control provides: a secure, web based system available twenty four hours a day, seven days a week, three hundred and sixty five days a year; 100% property accountability and visibility to assets at all times; integration of assets with 100% management, tracking and control of all assets despite their origin, current location or destination; assets tied to origin locations; assets tied to truck and trailer ids when in transit; assets tied to destination locations; multiple images support for each inventory item; fast, east inventory search; built in inventory reports—with multiple styles available, exportable to Microsoft Excel; and customizable inventory reports exportable to Microsoft Excel.

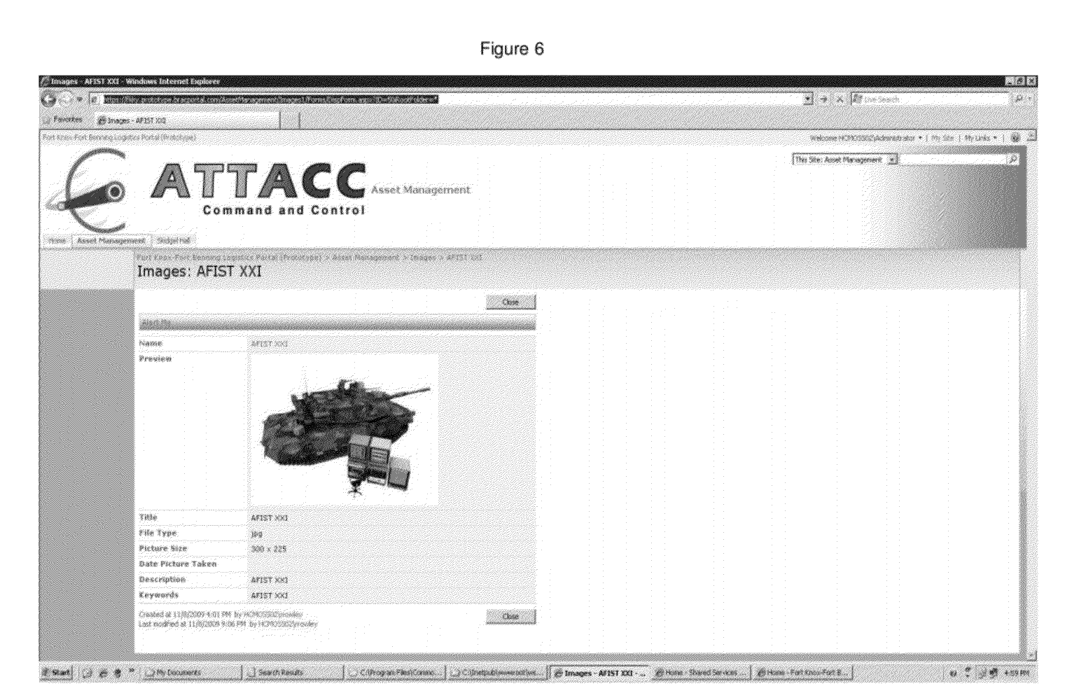

Referring now to FIG. 6, the image is representative of a drill down picture of a particular single image that is tied to a controlled asset. The system will allow a user to click on the image to download a full sized image for further inspection. Assets can have multiple images tied to them.

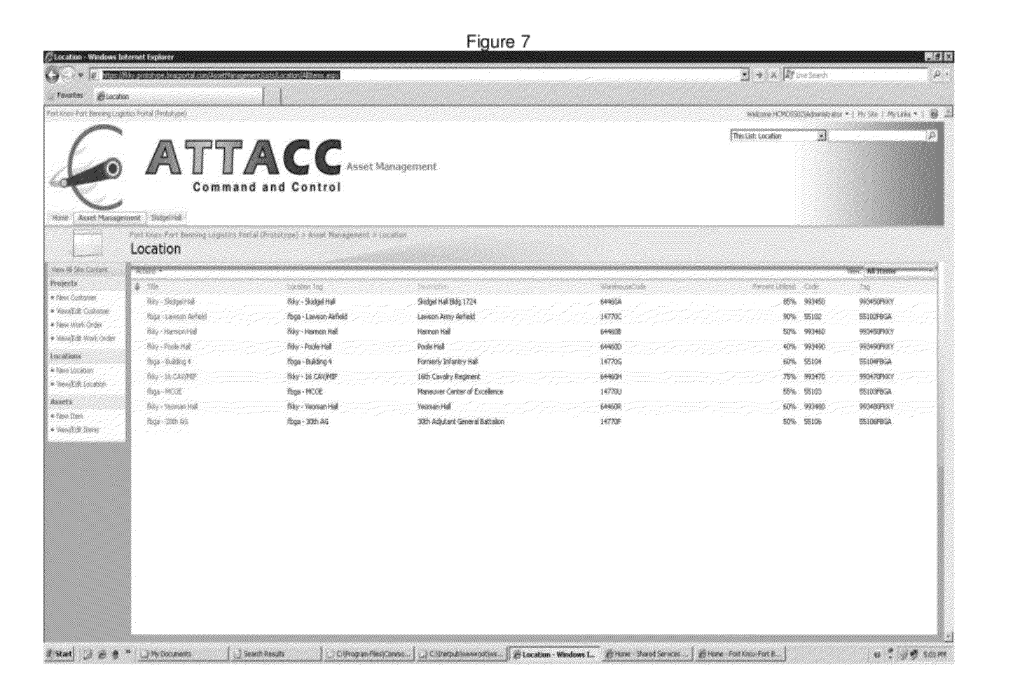

Referring to FIG. 7, a representative example of a master location repository for a sample project is shown. This list houses all the possible master inventory locations at both origin and destination. All assets must have an origin and destination and that origin and destination must exist in the locations master list. Other master lists may be present in the system's inventory control as well but are not shown here. Each master list serves a specific purpose—to ensure data integrity and ensure assets move with 100% property accountability.

In one embodiment, the system may provide remote asset management with in transit visibility (ITV) by integrating a third party technology or solution.

Using these integrated technologies, the system provides a number of important advantages:

### Electronic Inventory Control

By maintaining and supporting virtually unlimited amounts of electronic inventory tracking and management, the system provides a snapshot view of where all equipment and inventory is in the relocation process at any given moment in time. Easy to use, detailed reporting is also available at any moment in time.

### In-Transit Visibility

By enabling visibility of assets and cargo while on the move, integrated fleet technology helps better support real-time visibility through the system. Every vehicle will have its own “fingerprint”. Not having an asset identification (id) associated with a vehicle makes things fairly difficult when it comes to managing that vehicle and its assets. A fleet without asset ids assigned is a fleet that looks the same. Asset ids allow a fleet to be fingerprinted, and tracked for 100% accountability.

### Dispatch Optimization

By improving dispatching operations capability, the system optimizes dispatch efficiency and reduces downtime while awaiting next directive.

### Remote Monitoring & Control

By promoting real time monitoring of equipment, tanks and sensitive cargo, the system relays when a load is arriving and where, assists in reducing total equipment costs, improves maintenance planning, reduces liabilities for cargo loss and pre-empts operational failures.

### Safety & Security

By constantly monitoring the location and status of highly sensitive trailer assets and shipments, the system provides enhanced security protection for high-value and sensitive loads, improves detection of terrorism and other malicious threats.

Integrating and leveraging remote asset management technology provides the system with greater shipment visibility that will result in fewer in-transit disruptions and reductions in excess inventory. This includes visibility improvements across the entire move that ultimately reduce operating costs, improves reporting and enhances the accuracy and competitive advantage of the relocation team, strategy, and mission.

In one embodiment, for one relocation project where the inventory is special, priceless, and one of kind, the system may integrate a plurality of third party ITV solutions into one command and control view.

In one embodiment, ITV is tied to electronic inventory control allowing for 100% property accountability. In one embodiment, ITV is secured and asset visibility depends on clearance/access level. In one embodiment, ITV can be seen on a single map if desired or may be split out by individual load or carrier. In one embodiment, ITV data is stored and available for reporting or research as needed. In one embodiment, additional ITV detailed tracking may be provided for certain museum artifacts. All non sensitive ITV meets the one hour update (or sooner) ITV requirements. All sensitive ITV is tracked with 15 minute updates.

In one embodiment, ITV may provide 15 minute updates for both moving and non moving equipment. Detailed order/truck move history reports are supported. Map based locations using latitude/longitude are supported. The system integrates this to the chalk and inventory level tied to truck/trailer. The system has no visible/reporting on sensitive items as per COMSEC regulations, but sensitive items data is always tracked appropriately by Bennett secured cleared personnel.

In one embodiment, ITV may also provide one hour updates for moving equipment and three hour updates when assets are not moving (reached destination or sitting at origin or storage point). Detailed order/truck move history reports are supported. Map based locations using latitude/longitude are supported. The system integrates this to the chalk and inventory level tied to truck/trailer.

In one embodiment, the system uses AT&T Telenav ITV for sensitive, one of a kind, museum antiquity, precious cargo, or specialized, high value items. This provides a GPS receiver that can be attached in an innocuous (hidden) location on an individual sensitive or critical item. This is useful for tracking where a specific item of value and interest is at all times, prior to load, during transport, and after offload. AT&T's Telenav ITV provides 15 minute or less updates for both moving and non moving equipment. The GPS receiver unit has a 12 day battery life. Detailed receiver move history reports are supported. Map based locations using latitude/longitude are supported. The system integrates this to the chalk and inventory level tied to the individual asset.

If additional granular level reporting is needed or some other very detailed information or history of an item moved with a third party's ITV attached, system administrators can provide the report and access from the third party's system outside the system's portal. This is rarely required, but the option is available.

To help users stay in touch with project changes, the system includes a feature called Notifications, an e-mail and/or text messaging (SMS) notification service. When documents, lists, or items in the system are created, modified, or deleted, team members who so desire, can sign up for notifications and will begin to receive daily and periodic messages in real time as items are occurring that pertain to them, informing them that certain key changes have been made in the project as it relates specifically to them or their unit or responsibility.

The system allows participants to have notifications created for them to track items within the system, such as:
Project Issues—Users may be notified of changes to a particular project issue, such as when an issue is added, deleted, or changed.
Schedule or Inventory Changes—Users may be notified of changes to a particular chalk schedule, or delay as well as changes to project inventory on a chalk or individual level line item basis.
Document Repository—Users may be notified of changes to the project official documents of record, such as when a document is added, deleted, or changed in the repository or when discussions are added, changed, deleted, closed, or activated for a document.
Documents—Users may be notified of changes in a particular document or when web discussions are added, changed, deleted, closed, or activated for a document.

When a notification is created for one of these items, the user can specify what types of events will trigger the notification. Notifications will be generated whenever a document or list item is added, updated, or deleted, or when a discussion on a document or list changes by anyone. A user can specify one of these events, or select all of them to be notified whenever anything changes on the list, list item, document, or document repository they want to track.

In one embodiment, the system will allow authorized users to decide how often they want to receive notifications: immediately, daily, or weekly. Immediate notifications may be sent as individual e-mail messages, and daily or weekly notifications may be combined into summary messages for the entire user group.

In one embodiment, the system provides document repositories that store all the required transportation documents in a single web based folder. These folders feature automatic version control, document check-in and check-out (preventing users from saving on top of each other's changes), and customizable security and access permissions allowing users to see only what one is cleared to see, need to know basis. In one embodiment, the system includes a team calendar which adds project meetings, chalks (course and unit move schedules), and/or briefings and notes. The team calendar allows all participants or team members to view the same schedule. Reminders are configurable for meetings. The system allows team members to post any planned time off to the calendar.

In one embodiment, the system includes issue logs to track issues (also referred to as tasks or “due outs”), to assign issues to individuals to resolve, and to track the progress from beginning to end to ensure prompt and proper completion of an issue. The logs may be reviewed daily, and participants may view which issues they have been assigned. The system also allows team member to update their issues so the entire team involved may be aware of the progress. In one embodiment, the system provides weekly issues summary reports and on demand drill down reports.

In one embodiment, the system initiates a workflow that automatically requests (via email) feedback and/or approval and neatly consolidates responses into one location eliminating the hassle of juggling numerous emails and attachments. The system reduces the amount of email and voice communication by documenting all the issues, action items, schedules, and inventory, in a single, official place.

When utilizing the system to facilitate a project repository, and also while providing a collaboration platform to unite independent relocation teams, the first thing that normally comes to mind when analyzing security is the web tier. However, there are numerous planes of security that must be inspected when assessing an inclusive threat potential, the system provides the essential mechanisms to close this gap. It secures all project and collaboration mediums so that vital assets and operational data can be protected from potential compromise.

The system is well equipped to meet any industry's stringent security and compliance requirements such as military, government, financial, healthcare, medical and any other industry's requirements. The platform has a robust security model that provides management capabilities for controlling how it is configured in a network, controlling how users access the information, and controlling user access to content within the system.

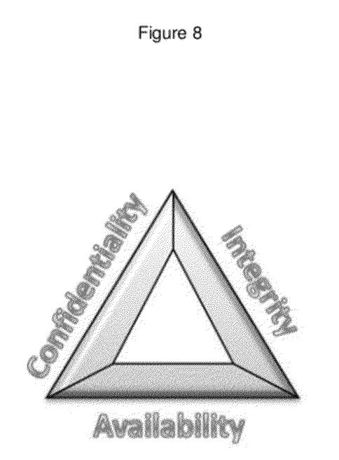

To better understand how security implemented by the system relates to proprietary information that may be protected in a project move, it is useful to show how it relates to a fundamental, universally accepted security standard such as the CIA Triad: Confidentiality, Integrity, and Availability (see FIG. 8). Although each of its layers has different weight for individual organizations, the CIA triad allows the focus to be shifted to highlight the highest risk for a particular environment, an adjustment that will influence settings for the system's security processes.

The CIA triad principles relate to the system's security principles as follows. The CIA triad principle, confidentiality, ensures that that information is only read and understood by trusted, authorized parties. The present system and method implements the principle of confidentiality by stopping information channel malware, such as viruses, Trojans, or rootkits, from accessing sensitive information in the system. The CIA triad principle, integrity, ensures that information has not been modified or destroyed by unauthorized parties. The present system and method implements the principle of integrity by ensuring that destructive material is quarantined and dealt with before damage occurs to the system and information stored within. The CIA triad principle, availability, ensures that information is readily accessible with a high level of service. The present system and method implements the principle of availability by ensuring that information is not infected when it is being submitted to, received from, or stored in the system which would affect data accessibility.

The system utilizes web servers and application pools. As is the case with any web site, a unique combination of IP address, port number, and host header on each web site is required in order for the system to run properly. Additionally, it will maintain a unique identity with respect to other nodes on the network in order for users on the network to be able to access the information.

Network configurations and services that exist between the users and the system's server including Domain Name Service (DNS), Windows Internet Name Service (WINS), firewalls, routers, switch ports, virtual Local Area Networks (LANs), will be configured in such a manner as to permit the user to access the system's portal. The hardware configuration of the server, the network configuration of the network, and the web server configuration of the web sites in the system provide secure user accessibility.

In order for project members to use information, the system will validate the person's identity. Referring to FIG. 7, the process flow illustrates the system's authentication process. The authentication process involves: A user points his or her browser at the portal and the web server performs the user validation using the authentication method that is configured for the environment. If the user authentication is successful, then the system will render the web pages based on the access level of the user. If authentication fails, the user is denied access to the site. The system supports three methods of authentication: Operating System (OS), HTTP/HTTPS web forms and Web Single Sign-On.

A single sign-on authentication method is used in environments that have federated identity systems or single sign-on systems configured. In this type of environment, an independent identity management system integrates user identities across heterogeneous directories and provides the user validation for the system. Large organizations often implement federated identity models to ease the administration of user provisioning and de-provisioning for systems that span across multiple organizations. This allows the end user to authenticate to systems with one set of credentials, rather than to use a different set of credentials for each unique system.

In one embodiment, the system may use a combination of authentication methods. This provides a great deal of flexibility because it makes it possible to serve a web application to different user departments or external entities which may have different identity requirements. For security and compliance reasons, it is necessary to store user accounts in active directory and partner user accounts in a SQL database.

The system allows users to search for content across many different content sources such as portals, web sites, network file shares, structured data stored in line of business systems, and people profiles stored within active directory and other custom data sources. The system's security model is fully integrated with the search feature, and therefore all of the content access concepts that apply to sites, web parts, and items also apply to search results.

There are several management controls available within the system that provide for custom tailoring of how content is crawled for search preparations, what content can be searched, and how the search results appear to the end users who are performing the search. Using these controls, the system may be configured to meet very unique and rigid security and compliance requirements for searching content.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

We claim:

1. A system to monitor and/or manage the logistics and transportation of equipment and/or inventory, the system comprising a web server tier, an application server tier and a database tier that employ real time tracking, vendor consolidation and reporting capabilities in a single secure web interface.

2. A method of monitoring and/or managing the logistics and transportation of equipment and/or inventory from origin to destination and final placement by using the system of claim 1.
